(19) United States
(12) Patent Application Publication
(10) Pub. No.: US 2006/0165981 A1
(43) Pub. Date: Jul. 27, 2006

(54) Method for brightening synthetic fibers and plastics with granulated optical brighteners

(76) Inventors: Thomas Martini, Kelkheim-Fischbach (DE); Jean-Luc Mura, Rixheim (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/524,931

(22) PCT Filed: Aug. 8, 2003
(86) PCT No.: PCT/EP03/08855

§ 371 Date: Feb. 16, 2006

(30) Foreign Application Priority Data
Aug. 14, 2002 (DE) 102 37 186.5

(51) Int. Cl. B29B 9/06; D01F 1/02; D02G 3/00

(52) U.S. Cl. 428/361; 264/118; 264/211; 428/372

(57) ABSTRACT

A method has been found for brightening synthetic fibers and plastics. In this method, a granulate optical brightener is incorporated into the synthetic fibers or plastics, the granulated optical brightener being obtained via compacting of an optical brightener in powder form in a pressure compactor under a pressure of from 3 to 50 kNewton/cm of tube length and then comminuting the resultant compactate.

Granulated, non-dusting and free-flowing non-ionic optical brighteners for plastics are described in DE 101 14 696.5-44. The granulated form of the brightener is achieved there via use of waxy substances to cover the brightener powder.

DE 26 56 406 describes the preparation of low-dust-level, preferably water-soluble optical brighteners via addition of dust binders, giving non-dusting mixtures. DE 39 10 275 describes a method for producing dye pellets, where the dye powder with water content of from 10 to 15% by weight is subjected to extrusion agglomeration. U.S. Pat. No. 3,583,877, too, requires addition of a solvent together with an insoluble additive, such as a wax, in the preparation of granulated basic dye. The methods described in EP 264 049, EP 115 634, or EP 612 557 likewise have to be operated in the presence of auxiliaries. WO 99/05226 describes the granulation of water-soluble dyes or optical brighteners in the presence of an extender or of other additives.

However, granulated materials prepared in that manner can give problems when used to brighten spun fibers of PES or PA, because the adherent additives cause problems during spinning of the threads, or can impair the running properties of the spun thread. Undesired side-effects can also arise during the recycling of ethylene glycol, for example if waxy substances form a cream and impair the quality of the ethylene glycol. Furthermore, yellowing of the fiber with reduced white effects can occur during exposure to high temperatures during fiber production or spinning.

For these reasons, only powder products have hitherto been used in the fiber brightening of PET and PA during fiber production, but those products are not flowable and tend to form dust during the charging process. The associated environmental and toxicological disadvantages of these dusts are known. Clumping and caking to the vessel walls can also occur during the metering of these powders. Granulated materials or pellets have good flow behavior and are therefore better suited to metering systems. A known industrial method is metering by means of a masterbatch, where the optical brightener has been dispersed in the polyester or plastic at high concentrations (up to 30%). However, the preparation of these masterbatches is very expensive and is likewise attended by the abovementioned environmental and toxicological problems. In addition, the intention is that a granulated brightener material be redispersible in ethylene glycol, if the system demands the use of an ethylene glycol/brighten dispersion.

Surprisingly, it has now been found that synthetic fibers and plastics can be brightened with the aid of granulated optical brighteners which are obtained by compressing a brightener powder at an elevated pressure and then comminuting it.

The invention provides a method for the brightening of synthetic fibers and plastics, which comprises incorporating a granulated optical brightener into the synthetic fibers or plastics, the granulated optical brightener being obtained via compacting of an optical brightener in powder form in a pressure compactor under a pressure of from 3 to 50 kNewton/cm of tube length and then comminuting the resultant compactate.

The granulated optical brighteners are produced via compacting in conventional pressure compactors between rolls or other pressure assemblies, e.g. extruder assemblies, preferably at the temperatures prevailing under the pressure conditions and at a pressure of from 5 to 50 kNewton/cm of tube length, preferably from 10 to 35 kNewton/cm of tube length. The resultant sheets or strands are then brought to a desired size via a comminution apparatus. In the case of compacting by means of pressure rolls, the optical brightener is conveyed by way of screws onto the rolls, so that precompacting takes place in the screw and the final compacting is carried out between the pressure rolls. The compacting temperature is reached without external supply of heat and can be from 15 to 60° C., preferably from 20 to 40° C. If required, the compacting can be carried out under nitrogen or in vacuo, with or without roller cooling. The strands, spirals, or sheets obtained via compacting are comminuted to the desired size by conventional methods, and the resultant granulated materials are freed from over- or undersize material via a sieving process using two or more sieves. The preferred compacted granulated materials have a preferred diameter of from 0.3 to 3 mm. However, granulated materials with a smaller or larger diameter may have properties which meet the desired requirements. The over- or undersize material removed by sieving is fed back to the granulating process.

The compacting granulation process can be carried out using commercially available granulators (e.g. the K series of compactors from BEPEX GmbH, Leingarten, Germany, or the WP 50/75, WP 17V Pharma, or WP 50/250 granulator from Alexanderwerk AG, Remscheid, Germany).

The resultant granulated materials feature dust-free behavior, and have good free-flow properties and stability, even during prolonged periods of transport. Furthermore, the inventive granulated materials have no tendency to cake or clump during metering, thus significantly increasing ease of processing. It has moreover been found that the inventive granulated materials have good redispersibility via stirring into, for example, ethylene glycol. These dispersions have good pumpability and can therefore be added by metering during polyester fiber production.

According to the invention, this method can granulate any of the non-ionic optical brighteners. These pelletized materials are used for the brightening of fully synthetic organic polymers (plastics and synthetic fibers). Irrespective of the chemical structure, the optical brighteners are those which absorb in the range from 260 to 400 nm and emit in the visible spectrum at from 400 to 450 nm. Preferred optical brighteners are those from the group of the benzoxazoles, thiophenes, stilbenes, or pyrazolines and coumarins. Particularly preferred optical brighteners are given by the formulae 1 - 5:
R=H and/or CH₃

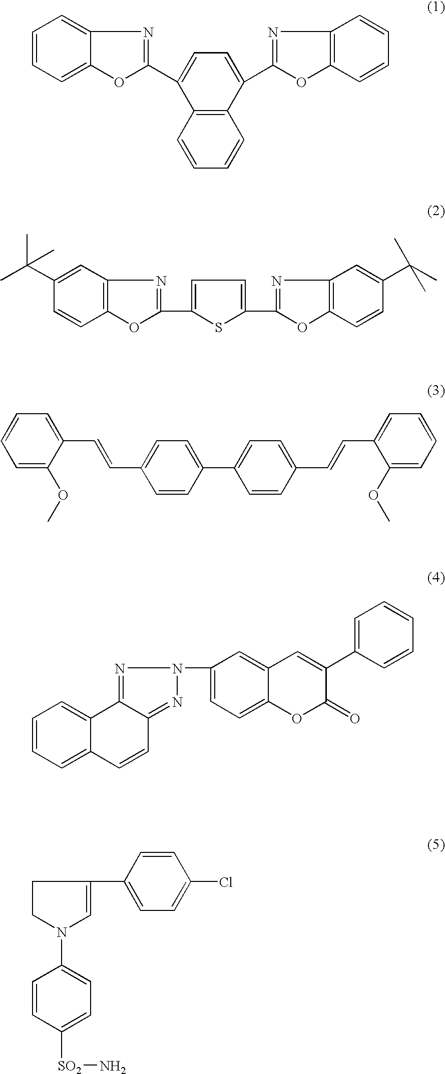

The amounts of optical brighteners, based on the plastic to be brightened, are normally from 1 to 1000 ppm, depending on the plastic or on the synthetic fiber and on the whiteness to be achieved. Larger amounts are possible in particular instances. It is also possible to use amounts of from 0.1 to 30%, based on the total weight of the plastic or the synthetic fiber, during the preparation of pre-concentrates. The optical brighteners may be used individually or in a mixture. Synergistic effects can also occur here. The optical brighteners may also be granulated together with shading dyes. It is, of course, also possible to granulate blends of granulated brightener materials with additives which cause no adverse effect during the incorporation process or the further processing of the plastic or of the fiber, e.g. blends with fiber stabilizers or with plastics stabilizers. The granulated materials can be used for the brightening of high-molecular-weight organic materials. These may be of natural or synthetic origin. By way of example, they may be natural resins, drying oils, or rubber, or modified natural substances, e.g. chlorinated rubber, or cellulose derivatives. The inventive granulated materials are preferably used for the brightening of polymers which have been prepared via polymerization, polycondensation, or polyaddition. From the class of the plastics prepared via polymerization, mention may particularly be made of the following: polyolefins, e.g. polyethylene, polypropylene, polyisobutylene, substituted polyolefins, e.g. polystyrene, polyvinyl chloride, polyvinylidene chloride, polyvinyl acetals, polyacrylonitrile, polyacrylic acid, and polymethacrylic acid and the respective esters, or polybutadienes, and also copolymers of these. From the class of the plastics prepared via polyaddition and polycondensation, mention may be made of: polyesters, polyamides, polyimides, polycarbonates, polyurethanes, polyethers, polyacetals, and also condensates of formaldehyde with phenols or urea, thiourea, or melamine.

The high-molecular-weight material mentioned may be an individual material or be present in a mixture in the form of plastics compositions or melts. However, the inventive granulated material may also be added to the respective underlying monomers, before carrying out the polymerization. The inventive granulated materials are particularly preferably suitable for the brightening of polyester.

In polyester fiber brightening, the optical brightener may be added by metering during the transesterification or esterification process, during polycondensation, or prior to spinning. By way of example, the optical brightener is metered in the form of an ethylene glycol dispersion or in the form of powder or in the form of masterbatch. If, by way of example, the optical brightener is added shortly prior to spinning by way of metering equipment (a hopper) to the mixing assembly in which the dried PET pellets are present, blocking can occur during the metering of powder within the hopper (e.g. Tamaki 80 D-LC-7K Blender), leading to interruption of the metering procedure. This problem can be avoided via the use of pellets or granulated materials. If the intention is that the optical brightener be added in an ethylene glycol dispersion to the esterification or transesterification process, or to the polycondensation, the granulated brightener materials can readily be redispersed via stirring, e.g. in a 15% strength brightener formulation.

### EXAMPLE 1

100 parts of a brightener of the formula 1 in powder form were compressed in a WP 50/75 compactor/granulator (roller length 75 mm, roller diameter 152 mm) at a roller pressure of 16 kNewton/cm of tube length and at a rotation rate of 8 rpm. This gave a molding of thickness 2 mm, which was granulated and gives pellets with a diameter of from 0.6 to 2 mm. The roller throughput was 31 kg/h, and the output of product with diameter from 0.6 to 2 mm was 85% after sieving. About 4.6 kg were fed back to the compacting process. The resultant granulated material has good free-flow properties and is dust-free. The dusting performance of the granulated material was determined photometrically, with the aid of sedimentation dust testing equipment. The dust number was 1. The dust number of the pulverulent substance of the brightener of the formula 1 underlying the granulated material is 13. (1=non-dusting, 16=highly dusting). The granulated material could moreover readily be redispersed in ethylene glycol via simple stirring.

### EXAMPLE 2

1000 g of dimethyl terephthalate (DMT)

720 g of ethylene glycol

0.23 g of manganese(II) acetate

were introduced into a 2 I flask equipped with a VA stirrer, a 20 cm packed column, and a condenser system. The heating bath was heated to 160° C., and, once the DMT had melted, the stirrer was started and the apparatus was flushed with a stream of N₂.

After removal of methanol by distillation had began, the temperature was raised every 15 minutes by 10° C. as far as 230-235° C., and kept at that level until all of the methanol had been removed distillation.

0.3 g of Sb₂O₃

0.09 g of H₃PO₃

4.0 g of TiO₂ (A type)

and 0.1 g of the granulated brightener of the formula: 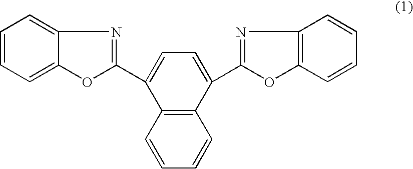
dispersed in ethylene glycol were then added to the 2 I flask, which had been provided with a condenser for glycol distillation and with a vacuum pump. The dispersion was obtained via stirring of the mixture at room temperature for 15 minutes. The bath temperature was increased to 250° C., and the flask was flushed with pure nitrogen. Stirring was begun as soon as the viscosity of the flask contents permitted this.

Once the transesterification product had melted completely, the N₂ stream was interrupted and the following polycondensation program was begun:

15 min at 790 mbar

15 min at 520 mbar

15 min at 250 mbar

15 min at 130 mbar

15 min at 55 mbar

15 min at 12 mbar

This procedure was supplemented via a temperature increase to 250-270° C. under a vacuum of at least 0.013 mbar, while keeping the stirrer speed constant at 180 rpm. Once the desired viscosity had been achieved, the heating system was removed and the flask, which is sprayed during cooling, is correspondingly protected.

The polyester composition was hydraulically broken and ground after CO₂ cooling. The material was dried at 120° C. for 5 h, and spun. This gave a homogeneously brightened fiber with excellent white effects.

### EXAMPLE 3

Operations were carried out as in Example 2. However, a conventional powder version was used instead of the granulated optical brightener of the formula 1. Undesired formulation of dust occurred during opening of the storage vessel and during the removal of the brightener. The white effects are identical with those of Example 1.

### EXAMPLE 4

Operations were carried out as in Example 2. However, the granulated optical brightener of the formula 1 was added without difficulty and without formation of dust to the transesterification process, together with the ethylene glycol. Uniformly brightened fibers were obtained and demonstrate that, here again, homogeneous dispersion of the granulated material takes place.

### EXAMPLE 5

Operations were carried out as in Example 2. However, a granulated material of the brightener of the formula 6 was used as brightener. Metering took place without formation of dust, and homogeneous brightening effects were obtained.

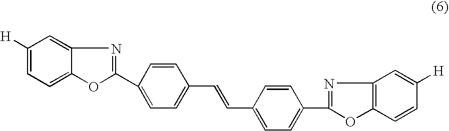

1. A method for the brightening of synthetic fiber or plastic comprising the step of incorporating a granulated optical brightener into the synthetic fiber or plastic, wherein the granulated optical brightener has at least one optical brightener and is obtained by compacting an optical brightener in powder form in a pressure compactor under a pressure of from 3 to 50 kNewton/cm of tube length to form a compactate and comminuting the compactate to from the granulated optical brightener.

2. The method as claimed in claim 1, wherein the at least one optical brightener of the granulated optical brightener absorbs in the range from 260 to 400 nm and emits in the visible spectrum at from 400 to 450 nm.

3. The method as claimed in claim 1, wherein the incorporating step further comprises adding the granulated optical brightener to the monomers of the synthetic fiber or plastic and polymerizing the fiber or plastic.

4. The method as claimed in claim 1, wherein the optical brightener comprises a shading dye.

5. The method as claimed in claim 1, wherein at least one optical brightener of the granulated optical brightener comprises a mixture of two or more optical brighteners.

6. A method for brightening synthetic fiber or plastic comprising the step of incorporating at least one granulated optical brightener into the synthetic fiber or plastic, wherein the granulated optical brightener has at least one optical brightener and is obtained by compacting an optical brightener in powder form in a pressure compactor under a pressure of from 3 to 50 kNewton/cm of tube length to form a compactate and comminuting the compactate to from the granulated optical brightener.

7. The method as claimed in claim 6, wherein the at least one granulated optical brightener is two or more granulated brighteners.

8. A brightened synthetic fiber made in accordance with process of claim 1.

9. A brightened plastic made in accordance with process of claim 1.

10. A brightened synthetic fiber made in accordance with process of claim 6.

11. A brightened plastic made in accordance with process of claim 6.
